(19) United States
(12) Patent Application Publication
(10) Pub. No.: US 2018/0178475 A1
(43) Pub. Date: Jun. 28, 2018

(54) MACHINE FOR MAKING BOX BLANKS

(71) Applicant: DIRK DEROSE, TULSA, OK (US)

(72) Inventor: DIRK DEROSE, TULSA, OK (US)

(21) Appl. No.: 15/392,880

(22) Filed: Dec. 28, 2016

(51) Int. Cl. B31B 50/22

(52) U.S. Cl. CPC B31B 1/25; B31B 1/02; B31B 1/16; B31B 2203/066; B31B 2201/145; B31B 2201/257; B31B 2201/0217

(57) ABSTRACT

In at least one embodiment, a machine for making a box blank from a sheet of box-making material includes a frame, a plurality of rollers, coupled to the frame, for moving the sheet along a material handling path, and a rail coupled to the frame adjacent to the material handling path. The machine further includes a carriage assembly including a first motor and a blade selectively deployable by the first motor, a second motor that, via a linkage, moves the carriage assembly along the rail, and a control circuit that controls the first and second motors to selectively deploy the blade to cut the sheet to form a box blank.

### BACKGROUND OF THE INVENTION

This disclosure relates to a machine for making box blanks.

Conventional machines that are currently utilized to mass-produce box blanks from sheet materials are extremely large, heavy, complex and expensive. These machines may make perhaps a hundred thousand of one size of box before being reconfigured to make another size. The size, weight, complexity and expense of such machines render then wholly unsuitable for environments in which only small runs of box blanks or box blanks of custom sizes are desired.

### BRIEF SUMMARY

Disclosed herein are various embodiments of a machine for making box blanks.

In at least one embodiment, a machine for making a box blank from a sheet of box-making material includes a frame, a plurality of rollers, coupled to the frame, for moving the sheet along a material handling path, and a rail coupled to the frame adjacent to the material handling path. The machine further includes a carriage assembly including a first motor and a blade selectively deployable by the first motor, a second motor that, via a linkage, moves the carriage assembly along the rail, and a control circuit that controls the first and second motors to selectively deploy the blade to cut the sheet to form a box blank.

In at least some embodiments, the machine is portable and weighs less than 100 pounds.

### BRIEF DESCRIPTION OF THE SEVERAL VIEWS OF THE DRAWINGS

FIG. 1 is an isometric view of a machine for making box blanks in accordance with one embodiment;

FIG. 2 is a partially exploded isometric view of an exemplary embodiment of the machine of FIG. 1 with its outer housing removed;

FIG. 3 illustrates a more detailed view of the rollers of a machine for making box blanks in accordance with one embodiment;

FIG. 4 depicts a more detailed view of the carriage drive mechanism of a machine for making box blanks in accordance with one embodiment;

FIG. 5 illustrates a more detailed view of a portion of the machine of FIG. 2 adjacent a second end of its carriage rail in accordance with one embodiment;

FIG. 6 is a first detailed view of a carriage assembly of a machine for making box blanks in accordance with one embodiment;

FIG. 7 is a top plan view of an actuator arm of the carriage assembly of FIG. 6 in accordance with one embodiment;

FIG. 8 is a second detailed view of the carriage assembly of FIG. 6;

FIG. 9 is an electrical circuit diagram of a machine for making box blanks in accordance with one embodiment;

FIG. 10 is a high level logical flowchart of the operation of a machine for making box blanks in accordance with one embodiment;

FIGS. 11A-11B together form a logical flowchart of the process by which a machine produces a box blank from a sheet of box-making material in accordance with one embodiment; and

FIG. 12 is a plan view of finished box blank produced by a machine for making box blanks in accordance with one embodiment.

### DETAILED DESCRIPTION

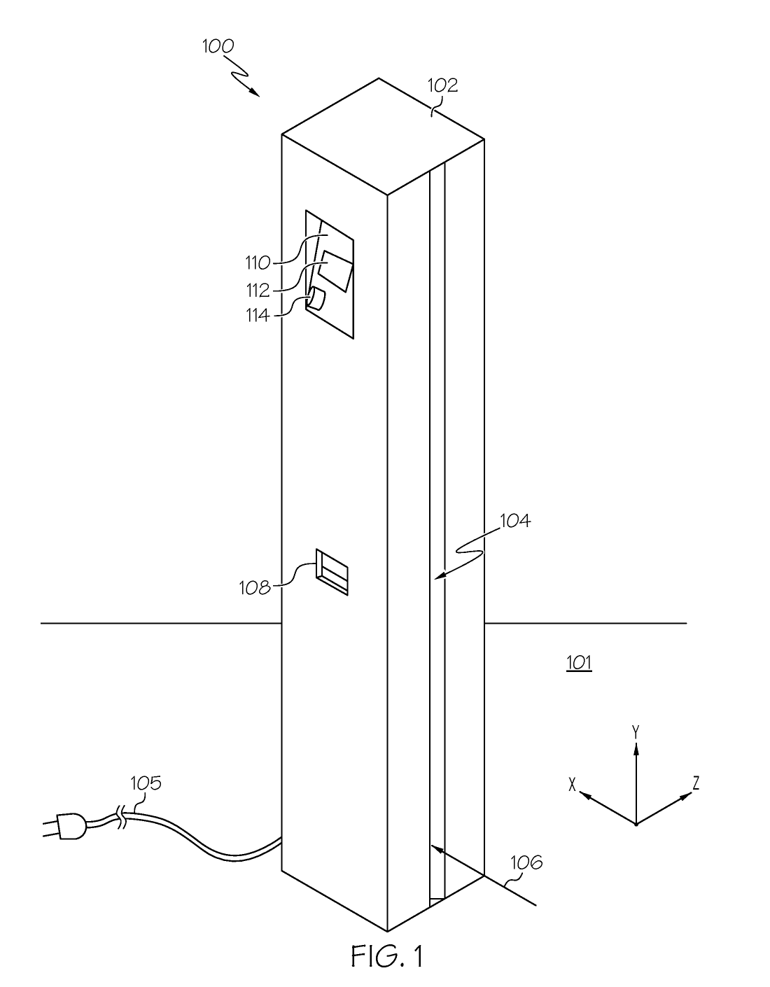

With reference now to the figures and with particular reference to FIG. 1, there is illustrated an isometric view of a machine 100 for making box blanks in accordance with one embodiment. Machine 100 includes a housing 102 that encloses the mechanical, control and electrical components of machine 100.

In the illustrated embodiment, housing 102 has the form of an elongate rectangular prism having a pair of aligned slots 104 formed through opposing sidewalls (only one slot 104 can be seen in the view given in FIG. 1). Slots 104 define a material handling path 106 for a planar sheet of box-making material, such as corrugated paperboard (cardboard) or corrugated plastic. Although dimensions of housing 100 can vary between embodiments, in one representative embodiment in which slots 104 are sized to receive therein sheets of box-making material that are up to four feet in width, housing 102 can be approximately 12 inches in length and in depth, 54 inches in height, and approximately 50 pounds in weight. In other embodiments, machine 100 can be designed such that the weight of machine 100 is less than 100 pounds, less than 90 pounds, less than 80 pounds, less than 70 pounds or less than 60 pounds. In embodiments such as that shown, slots 104 are substantially orthogonal to an underlying substrate (e.g., vertical), advantageously reducing the area of substrate 101 (i.e., minimizing the floor space) required by machine 100; in other embodiments, slots 104 can instead be oriented parallel (or at another angle) to substrate 101. Because of its small dimensions and low weight as compared to prior art machines for making box blanks, machine 100 can be portable and can be readily manually lifted and transported by one person. To facilitate handling and carrying of machine 100, housing 102 may optionally be equipped with one or more handles or handholds 108 (in this exemplary embodiment, a concavity formed into housing 102).

In a preferred embodiment, machine 100 is electrically powered by standard mains power (e.g., 110-232 V at 50-60 Hz), to which machine 100 can be connected by power cord 105. Machine 100 has a control panel 110 that may support a display 112 (e.g., a touch screen or liquid crystal display (LCD)) and may further support an additional user input device 114 (in the illustrated embodiment, a multifunction knob), and optionally, an audio speaker (not explicitly illustrated in FIG. 1) to present audio outputs. As discussed further below, a user may input a desired size for a box (e.g., utilizing the touchscreen and/or user input device 114) and may receive instructions or operational feedback via display 112 and/or the speaker.

To facilitate understanding, the following description will reference the three-dimensional Cartesian coordinate system depicted in FIG. 1. In this coordinate system, the X axis is defined to be along material handling path 106, the orthogonal Y axis is the axis aligned with the long axis of machine 100, and the Z axis is orthogonal to the X and Y axes. Although the following description may employ relative positional terms (e.g., “upper” and “lower”, “top” and “bottom”, “vertical” and “horizontal”, etc.) with reference to this coordinate system, it should be understood that such terms are employed to promote understanding of machine 100 and its operation and should not be construed as limiting the scope of the appended claims.

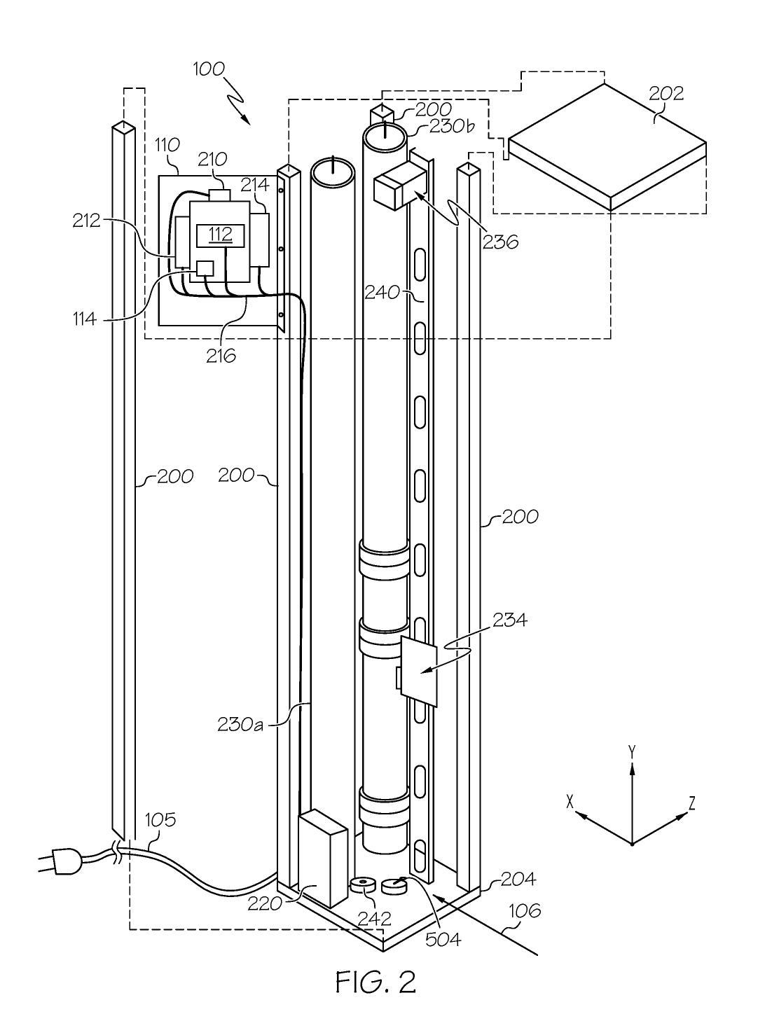

Referring now to FIG. 2, there is depicted a partially exploded isometric view of an exemplary embodiment of the machine 100 of FIG. 1 with its housing 102 removed. Housing 102 is supported by a frame, which in this embodiment, includes a plurality of columns 200 and a top plate 202 and bottom plate 204 coupled to columns 200. In other embodiments, a greater or lesser number of structural elements may be utilized to form the frame. The frame made be made of any of (or a combination of) a wide variety of materials, such as wood, medium density fiberboard (MDF), metal (e.g., aluminum or steel), plastic, fiberglass, etc. The materials and design of the frame, which may vary between embodiments, are preferably selected to provide sufficient structural integrity for machine 100 to operate as described herein.

The frame and/or housing 102 of machine 100 supports the control panel 110 previously illustrated in FIG. 1. In the view given in FIG. 2, control panel 110 is illustrated in rear elevation and is shown as hingedly coupled (for the purpose of component accessibility) to a column 200. In addition to the display 112 and user input device 114 previously described, control panel 110 supports a control circuit 210, a stepper motor driver 212, and one or more motor relays 214. These components (and others) are electrically coupled as described further herein via a wiring harness 216. In various embodiments, control circuit 210 can be implemented with various types of controllers. For example, in some embodiments, control circuit 210 can be implemented with an appropriately programmed processor, such as an Arduino or Raspberry Pi microprocessor, or with an application specific integrated circuit (ASIC), programmable logic array (PLA) or field-programmable gate array (FPGA). Control circuit 210 and the other electrically-powered components of machine 100 are powered by a power supply 220, which may provide one or more power supply voltages (e.g., 28 VDC, 24 VDC, 5 VDC, 3 VDC, etc.) from the input standard mains power received via power cord 105.

The frame of machine 100 further supports and holds in fixed relation a pair of rollers 230a, 230b and a rail 232 all aligned with the Y axis along material handling path 106. Rail 232 in turn supports a carriage assembly 234 including a toolset utilized to facilitate cutting, scoring and perforating a sheet of box-making material to produce a box blank. A carriage drive mechanism generally indicated at reference numeral 236 (which in one embodiment features a stepper motor) moves and positions carriage assembly 234 at various locations along rail 232 during the production of the box blank.

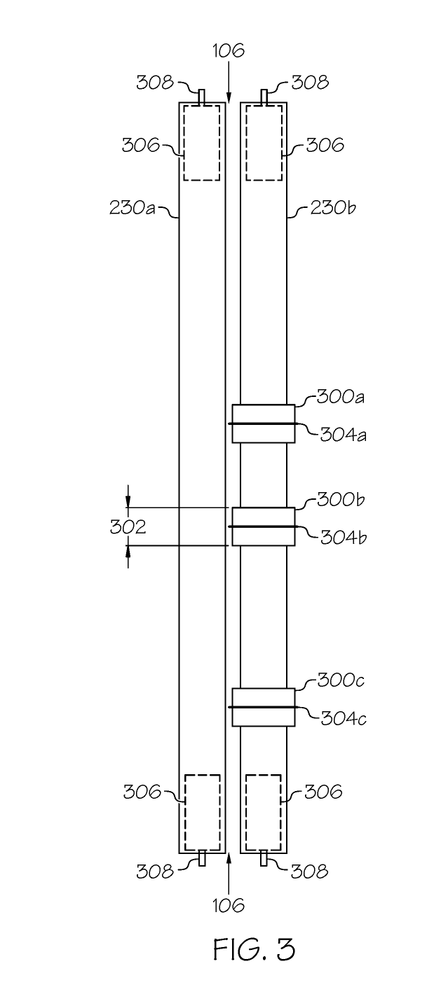

With reference now to FIG. 3, there is illustrated a more detailed view of rollers 230a, 230b of FIG. 2 in accordance with one embodiment. In the illustrated embodiment, rollers 230a, 230b are hollow tubular rollers with circular cross-sections. In a preferred embodiment, rollers 230a, 230b are formed of one or a combination of rigid materials, such as aluminum, steel, and/or plastic (e.g., polyvinyl chloride (PVC)). For example, in one specific example, rollers 230a, 230b can be 14 gauge round steel tubes with an outer diameter of 1.875 inches and a height of 52 inches.

Mounted on one or both of rollers 230a, 230b are a plurality of sleeves 300a, 300b and 300c. Sleeves 300a, 300b, and 300c, which will hereafter be assumed to all be mounted on roller 230b, are slidable along sleeve 300b (i.e., along the Y axis) under the urging of the toolset of carriage assembly 234, but fit snugly enough about roller 300b to resist displacement along the Y axis under the downward force of gravity alone. Sleeves 300a-300c can be formed, for example, of PVC or other rigid or substantially rigid material and may have a dimension along the Y axis of, for example, 1.625 inches. The height 302 of sleeves 300a-300c determines the minimum distance between fold lines scored into the box-making material by the toolset of carriage assembly 234 and can vary between embodiments based on the desired range of box dimensions and the box-making material employed.

Each of sleeves 300a-300c has a respective circumferential or annular raised ridge 304a-304c, which is used to continuously score a sheet of box-making material along the X axis. In various embodiments, ridges 304a-304c may be formed integrally to sleeves 300a-300c, or alternatively, may be formed utilizing a separate part, such as a rubber O ring. In one exemplary embodiment, ridges 304a-304c may have an outer diameter of 2.5 inches, resulting in a ridge height of 0.25 inches and a gap between each of ridges 304a-304c and roller 230a of approximately 0.03 inches, which is suitable for forming regular slotted containers (RSCs) from C flute corrugated cardboard having a nominal thickness of 5/32 inch. In other embodiments intended for different box-making material or corrugated cardboard of different weight, the dimension of ridges 304a-304c and the gap between ridges 304a-304c and the surface of opposing roller 230a can vary.

As further illustrated in FIG. 3, each of rollers 230a-230b is preferably powered by one or more (and in a preferred embodiment, two) axial gear motors 306 disposed within a cavity (e.g., the hollow interior) of that roller 230a or 230b. For each axial gear motor 306, the motor's housing is fixed relative to its respective roller 230, and the motor shaft 308 is fixed relative to the frame of machine 100, meaning that, when actuated via motor relays 214, the motor's housing (and thus the associated roller 230) turns. Axial gear motors 306 are arranged to counter-rotate rollers 230a-230b about motor shafts 308 under the control of control circuit 210 in order to move a sheet of box-making material back and forth along material handling path 106 (i.e., along the X axis). The disclosed arrangement of axial gear motors 306 and rollers 230 has a number of advantages, including dual use of the motors' bearings as roller bearings (an additional roller bearing will be used in embodiments using only a single motor for a roller 230), which reduces weight and the overall parts count. In addition, the torque imparted by motors 236 is evenly applied. Interior volume within housing 102 is also conserved through utilization of otherwise unused space inside rollers 230, and removal and/or replacement of a roller/motor assembly, when necessary for servicing, is simplified. Further, axial gear motors 306 and the associated wiring are protected from dust generated by the cutting process and from entanglement.

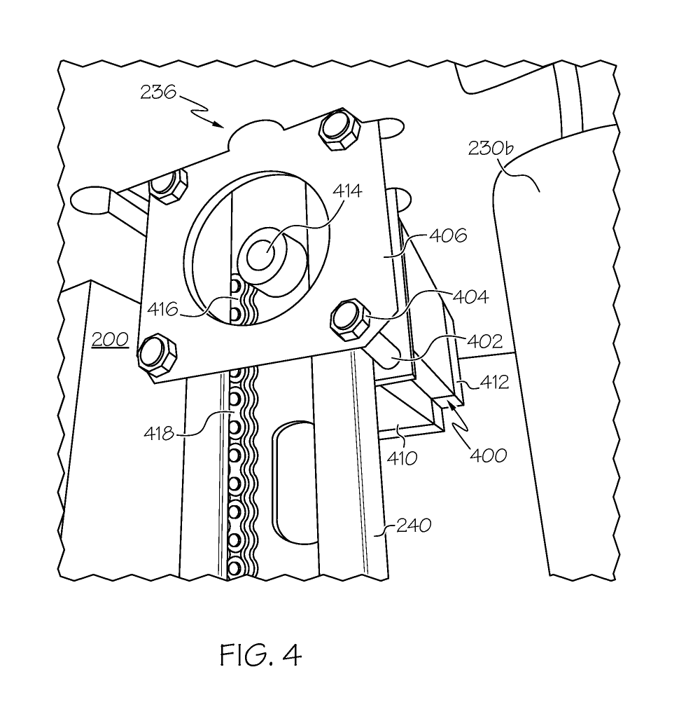

Referring now to FIG. 4, there is depicted a more detailed view of a carriage drive mechanism 236 of FIG. 2 in accordance with one embodiment. In the illustrated embodiment, carriage drive mechanism 236 includes a carriage drive motor housing 400 mounted (in this example, by bolts 402, nuts 404 and a mounting plate 406) at a first end (e.g., the upper end) of rail 232. In the illustrated embodiment, carriage drive motor housing 400 contains an electric stepper motor 410 (e.g., a NEMA 23 stepper motor) and a motor encoder 412. In an alternative embodiment, a properly-sized DC motor with a feedback system (i.e., a servo motor) for tracking incremental positioning can be utilized in place of the stepper motor 410 included in the illustrated embodiment. The carriage drive mechanism 236 further includes a linkage coupling the carriage drive motor 410 and carriage assembly 234. For example, in the illustrated embodiment, carriage drive motor 410 has a shaft 414 to which a sprocket 416 is fixedly coupled. Sprocket 416 in turn engages a drive chain 418 to which carriage assembly 234 is coupled. With this arrangement, as shaft 414 is rotated clockwise or counterclockwise by stepper motor driver 212 and stepper motor 410 under the control of control circuit 210, sprocket 416 engages drive chain 418, moving carriage assembly 234 to desired positions along rail 232.

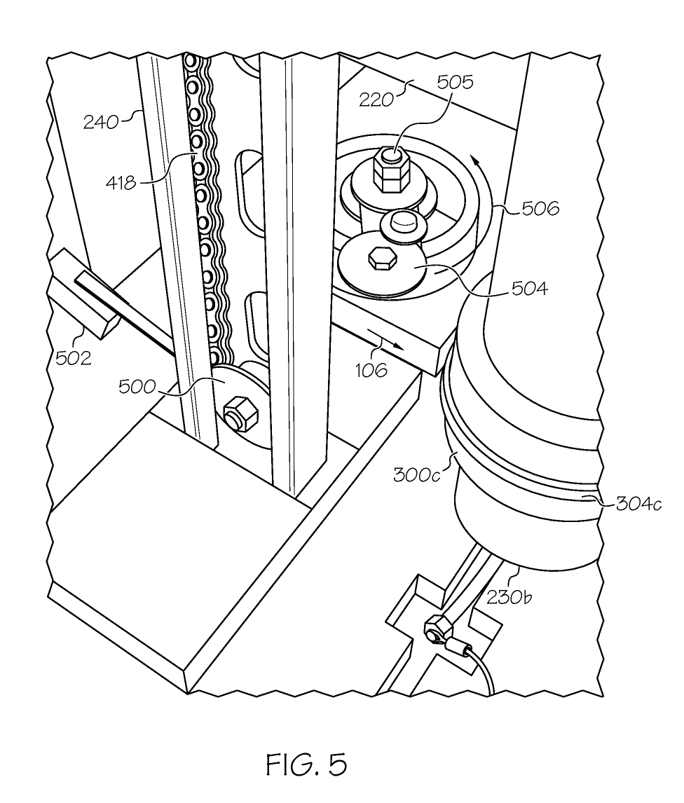

With reference now to FIG. 5, there is illustrated a more detailed view of a portion of machine 100 adjacent a second end (e.g., the lower end) of rail 232 in accordance with one embodiment. As shown, an idler pulley 500 is rotatably mounted at or near the second end of rail 232. Drive chain 418 runs about idler pulley 500, and idler pulley 500 is preferably positioned along rail 418 to impart (in concert with sprocket 416) a desired tension to drive chain 418. A limit switch 502 communicatively coupled to control circuit 210 is disposed adjacent rail 232. Limit switch 502 closes to provide feedback to control circuit 210 when carriage assembly 234 is positioned at or near the second end of rail 232.

FIG. 5 further illustrates that a first X cutting blade 504 is pivotally mounted to the frame of machine 100 near the second end of rail 232 and adjacent material handling path 106. In a preferred embodiment, the operation of X cutting blade 504 is passive, meaning that X cutting blade 504 cuts box-making material along the X axis as the material is moved along the material handling path 106 by rollers 230a-230b, but is not itself powered. Specifically, in the illustrated embodiment, X cutting blade 504 pivots about point 505 out of material handling path 106 in the direction indicated by arrow 506 as X cutting blade 504 is pushed by a sheet of box-making material being fed forward along material handling path 106 by rollers 230a-230b, but pivots in the opposite direction under the urging of an unillustrated spring and cuts the sheet of box-making material along the X axis as rollers 230a-230b move the sheet of box-making material in the reverse direction along material handling path 106. While the box-making material is traveling in the reverse direction, contact between the box-making material and blade 504 causes friction which is useful (in concert with the unillustrated spring) for locking X blade 504 into a position that is optimal for this phase of cutting. In alternative embodiments in which carriage assembly 234 has a sufficient range of travel to permit cuts along the Y axis to be made all the way to the lower edge of the sheet of box-making material, machine 100 may omit X cutting blade 504.

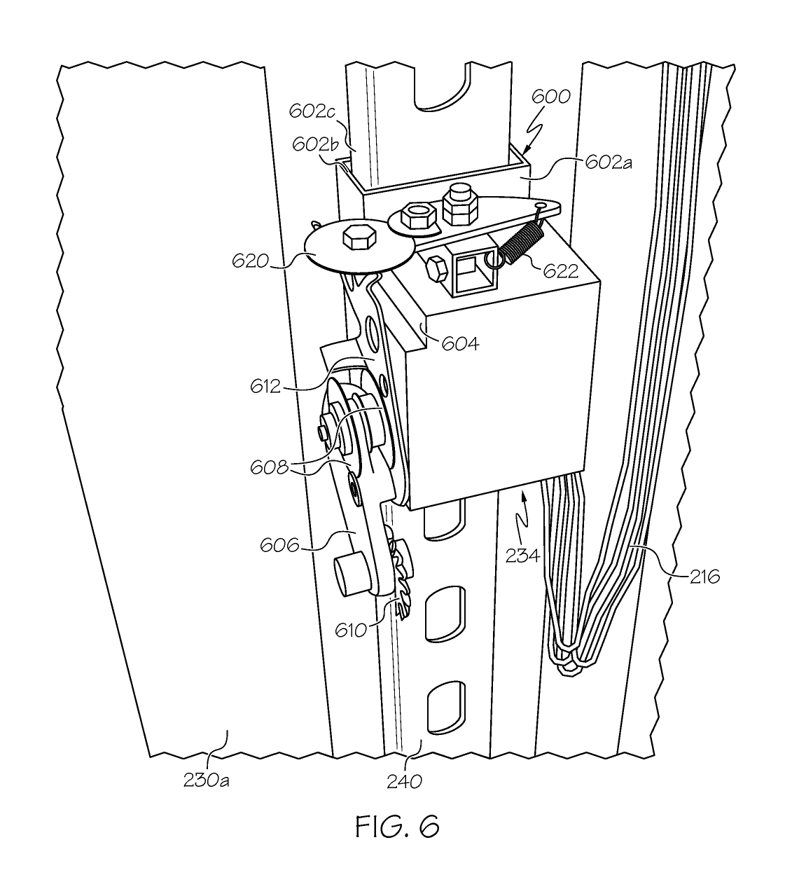

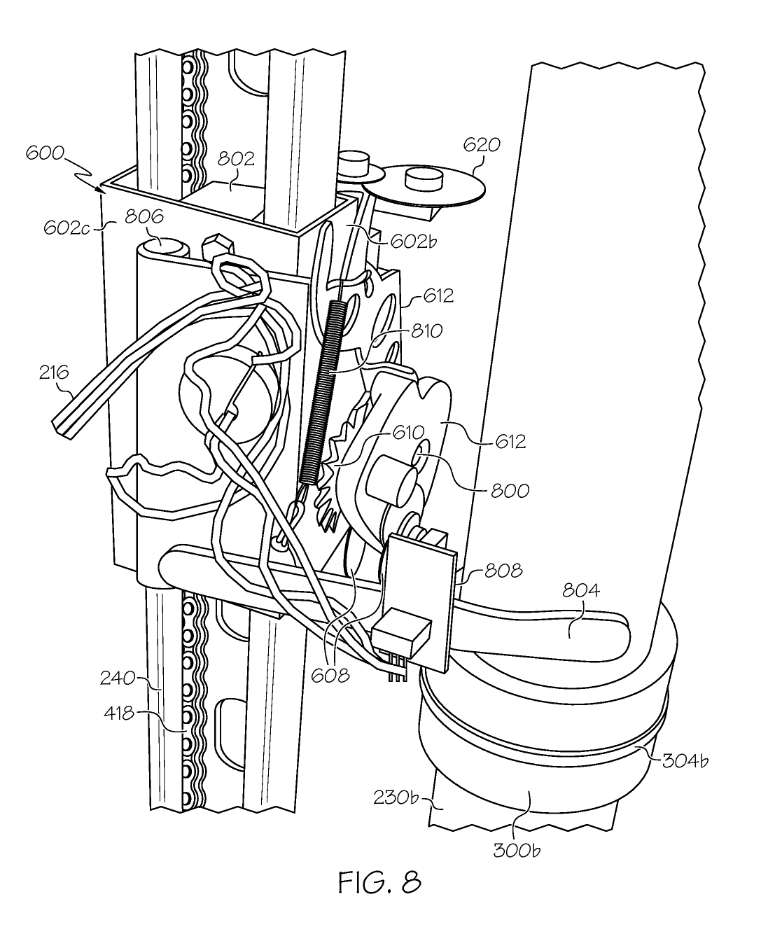

Referring now to FIGS. 6 and 8, there are depicted more detailed views of carriage assembly 234 of FIG. 2 in accordance with one embodiment. Carriage assembly 234 includes a carriage 600 having at least a first surface 602a, a second surface 602b substantially perpendicular to first surface 602a, and a third surface 602c substantially parallel to first surface 602c. As best seen in FIG. 8, in the depicted embodiment, carriage 600 is attached to drive chain 418 by a carriage attachment block 802 so that carriage 600 slides along rail 232 in either direction as drive chain 418 is driven backwards and forwards by stepper motor 410 and sprocket 416.

A servo motor 604 that operates the toolset of carriage assembly 234 under the control of control circuit 210 is mounted on first surface 602a. When energized via wiring harness 216, servo motor 604 preferably deploys from the toolset of carriage assembly 234 only a single selected tool at any one time. In a preferred embodiment, the carriage assembly 234 and toolset can be used to perform the following functions: (1) cutting a sheet of box-making material along the X axis, (2) changing the locations of one or more of sleeves 300 along the Y axis, (3) traversing the rail without any tool-to-material contact, (4) double-cutting a sheet of box-making material along the Y axis, and (5) scoring box-making material along the Y axis.

The shaft 800 of servo motor 604 is fixedly coupled to a tool head 606 by a single fastener as best seen in FIG. 8. Tool head 606 has mounted thereon a pair of spaced Y cutting blades 608 and a Y scoring wheel 610, which in the illustrated embodiment takes the form of a star-shaped blade. Y cutting blades 608 are utilized to cut the sheet of box-making material along the Y axis, and Y scoring wheel 610 is utilized to score (perforate) the sheet of box-making material to facilitate forming the corners of the box.

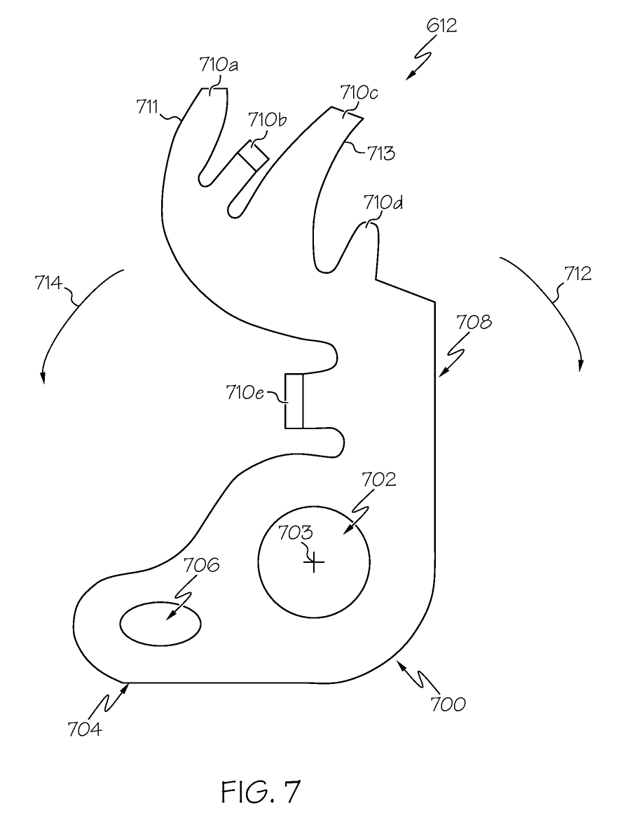

As tool head 606 is rotated by servo motor 604 about servo motor axle 800, tool head 606 engages and pivots an actuator arm 612 coupled thereto. With additional reference now to FIG. 7, there is illustrated a top plan view of actuator arm 612 in accordance with one embodiment. As shown, actuator arm 612, which is preferably formed of a rigid material such as a metal or plastic, has a generally planar form. Actuator arm 612 includes a generally ovoid central portion 700 having a hole 702 formed therein through which the shaft of servo motor 604 extends. The center point 703 of hole 702 is the point around which actuator arm 612 rotates in both a clockwise direction 712 and a counter-clockwise direction 714. Extending from central portion 700 is a first leg 704 that is used for stabilizing actuator arm 612 and through which an optional hole 706 may be formed. A second leg 708 that is substantially orthogonal to first leg 704 also extends from central portion 700.

Second leg 708 has five fingers 710a-710e extending therefrom. The end of finger 710d is bent and extends from the plane of actuator arm 612 (e.g., away from the viewer in FIG. 7). Finger 710d is used as a physical stop at the design limit of rotation of the actuator arm 612 in counter-clockwise direction 714. The ends of fingers 710b and 710e bend and extend from the plane of actuator arm 612 (e.g., toward the viewer in FIG. 7). As best seen in FIG. 8, the bend in finger 710b supports the attachment of an actuator arm spring 810. The bend in finger 710e permits tool head 606 to engage and pivot actuator arm 612 as tool head 606 is rotated by servo motor 604. Rounded edge 711 of finger 710a serves as a bearing surface to move sleeve engagement arm 804 away from roller 230b as actuator arm 612 is rotated in counter-clockwise direction 714. Rounded edge 713 of finger 710c serves as a bearing surface to actuate the lever moving X-axis blade 620 as actuator arm 612 is rotated in clockwise direction 712.

Referring again to FIG. 6, the toolset of carriage assembly 234 additionally includes a second X cutting blade 620 for cutting sheets of box-making material along the X axis. X cutting blade 620 is pivotally mounted on the housing of servo motor 604. Cutting blade 620 is biased (e.g., by spring 622) away from material handling path 106 so that, unless deployed by servo motor 604, cutting blade 610 is positioned so that it does not cut a sheet of box-making material within material handling path 106. If, however, control unit 210 determines to cut the box-making material along the X axis utilizing second X cutting blade 620, control unit 210 energizes servo motor 604 to cause tool head 606 to pivot finger 710c of actuator arm 612 into contact with the pivot arm supporting second X cutting blade 620, thus moving second X cutting blade 620 into the material handling path 106. In the illustrated embodiment, second X cutting blade 620 is designed to cut the sheet of box-making material when the material is traveling in the reverse direction (i.e., out of entrance slot 104). As in the case of first X cutting blade 504, the friction between the box-making material and second X cutting blade 620 forces the pivot arm supporting second X cutting blade 620 to be locked into the position optimal for blade 620 to penetrate the sheet of box-making material. As a result, the sheet of box-making material will be cut along the X axis by X cutting blade 620 as the sheet of box-making material is fed in the reverse direction along material handling path 106 by rollers 230a, 230b. Implementing X cutting blades 504 and 620 as passive as opposed to powered blades streamlines the design and reduces the weight of machine 100, and in the case of X cutting blade 620, specifically reduces the weight and complexity of carriage assembly 234.

Referring specifically now to FIG. 8, the toolset of carriage assembly 234 additionally includes a hinged sleeve positioning arm 804, which in the depicted embodiment is mounted on third face 602c of carriage 600 and rotates about axle 806. Sleeve positioning arm 804 is biased toward roller 230b by spring 810, which serves not only to bias sleeve positioning arm 804, but also to impart the return motion to actuator arm 612. In the disengaged position, sleeve positioning arm 804 does not contact any of sleeves 300a-300c as carriage 600 moves along rail 232. As specifically shown in FIG. 8, sleeve positioning arm 804 also has an engaged position in which sleeve positioning arm 804 is rotated toward roller 230b by the urging of the biasing spring 810 and contacts roller 230b. In this position, as carriage 600 is driven up or down rail 232, sleeve positioning arm 804 is utilized to position one or more of sleeves 300a-300c along the Y axis in order to score a sheet of box-making material at the appropriate locations along the X axis to form fold lines for the desired box size. While sleeve positioning arm 804 is in the engaged position, control unit 210 may also rotate at least roller 230b in order to facilitate the translation of one or more of sleeves 300a-300c along roller 230b. In the illustrated embodiment, sleeve positioning arm 804 additionally carries a sensor 808 (e.g., an infrared optical sensor) for determining and initializing the position of each of the sleeves 300a-300c.

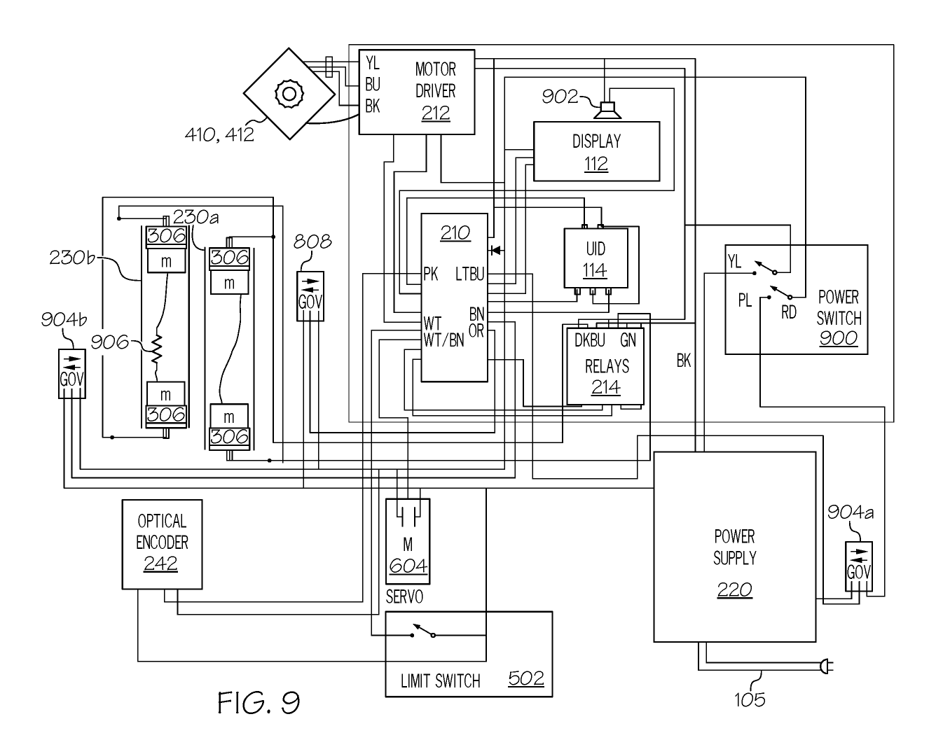

With reference now to FIG. 9, there is illustrated an electrical circuit diagram of machine 100 in accordance with one embodiment. In the depicted embodiment, power supply 220 receives input AC power (e.g., standard mains power) via power cord 105 and provides one or more output DC voltages (e.g., 28 VDC, 24 VDC, 5 VDC, 3 VDC, etc.) to power the other electrical components of machine 100. The provision of power by power supply 220 can optionally be controlled by a power switch 900.

Control circuit 210 is coupled to receive inputs from user input device (UID) 114 and to provide outputs via display 112 and optional speaker 902. Control circuit 210 is further coupled to motor driver 212, which is, in turn, coupled to stepper motor 410 and motor encoder 412. Control circuit 210 provides inputs to motor driver 212, which cause motor driver 212 to position carriage assembly 234 at desired locations along rail 232, and receives motor position feedback signals from motor encoder 412 via motor driver 212. Control circuit 210 is also coupled to servo motor 604 and controls the position of the shaft of servo motor 604. Control circuit 210 is additionally coupled to relays 214, which, when energized, power the axial gear motors 306 that drive rollers 230a, 230b.

In the illustrated embodiment, the two axial gear motors 306 within each roller 230 are wired in series with each other. For example, if axial gear motors 306 employ 12 VDC input power, 24 VDC is applied across each pair of axial gear motors 306, which are electrically connected in parallel. Because the outer circumference of roller 230b is effectively larger than that of roller 230a by virtue of the height of annular raised ridges 304a-304c, a resistor 906 is connected in series with the axial gear motors 306 powering roller 230b in order to slow the angular velocity of the outer surfaces of annular raised ridges 304a-304c to match that of the mating surface of roller 230a.

In a preferred embodiment, power is supplied to axial gear motors 306 in an unconventional manner. Instead of using conventional brushes or wipers, power is preferably delivered to the pair of axial gear motors 306 via each of the two motor shafts 308 and each motor's metal housing, which is electrically connected directly to one of the motor's power lugs. (Rollers 230 are electrically insulated from the housings of axial gear motors 306 at least in embodiments in which rollers 230 are made of metal or other conductive material.) Thus, in each motor pair, the motor shaft 308 of one axial gear motor 306 is connected to the positive potential, the motor shaft 308 of the other axial gear motor 306 is connected to the negative (or ground) potential, and the two motor housings are connected in series. The connections of the other motor pair are simply reversed to cause counter-rotation.

FIG. 9 further illustrates that machine 100 includes a plurality of sensors coupled to control circuit 210 to provide inputs regarding the position of the sheet of box-making material. Such sensors could effectively use physical contact, infrared or white light, sound or laser to determine object position. In the depicted embodiment, these sensors include an infrared sensor 904a that senses when the material enters the work space, an infrared sensor 904b that senses when the sheet of material begins to protrude past rollers 230a and 230b, and an infrared sensor 808 mounted on sleeve engagement arm 804 that senses the position of sleeves 300a, 300b and 300c. Each of these sensors has ground (G) and voltage (V) terminals coupled to power supply 220 and an output (O) terminal coupled to control circuit 210. The sensors illustrated in FIG. 9 further include a rotating optical digital encoder 242 (also depicted in FIG. 2) having a frictional (e.g., rubber) wheel that contacts roller 230a. When roller 230a rotates, moving the box-making material along material handling path 106, the encoder wheel rotates an amount proportional to the linear translation of the box-making material along the X axis and generates signals indicative of the rotation. These signals (e.g., a train of pulses) can be processed by control circuit 210 to determine the position of the sheet of box-making material along the X axis and/or the distance traversed. The sensors depicted in FIG. 9 additionally include a limit switch 502, which can trigger control unit 210 to stop the downward travel of carriage assembly 234 when it reaches its lowest design position.

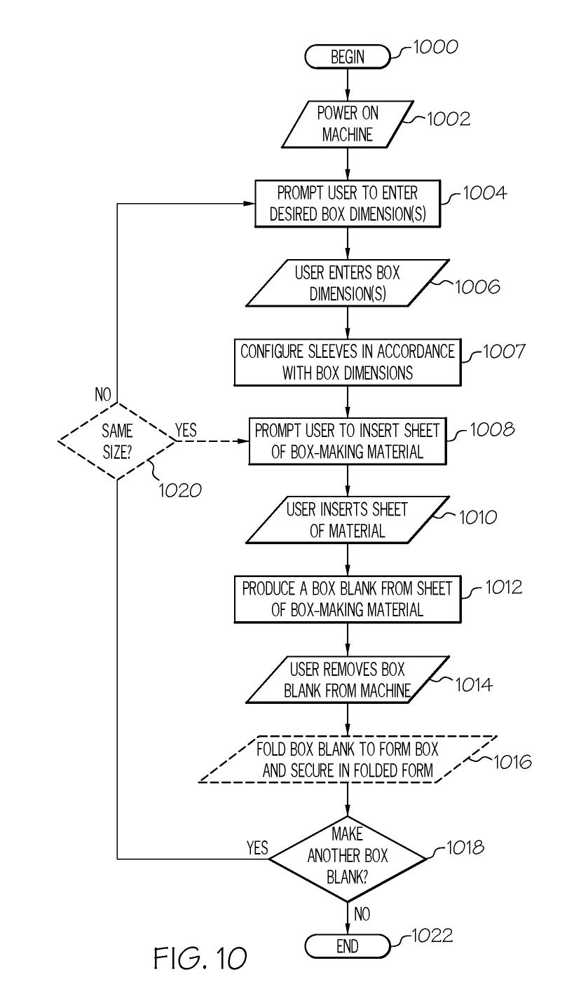

Referring now to FIG. 10, there is depicted a high level logical flowchart of the operation of a box-making machine in accordance with one embodiment. The process begins at block 1000 and then proceeds to block 1002, which illustrates a user providing power to machine 100, for example, by connecting power cord 105 to standard mains power and/or switching power switch 900 from an “off” position to an “on” position. The process then proceeds to block 1004, which depicts control unit 210 presenting via display 212 and/or speaker 902 a prompt for the user to enter the desired dimension(s) of a finished box (e.g., length, width and height or, in an alternative embodiment, volume). In at least some embodiments, one or more of the dimensions of the finished box may default to a predetermined default dimension. In at least some embodiments, control unit 210 constrains each of the input dimensions between predetermined minimum and maximum dimensions (which may vary between the length, width and height). In at least some embodiments, control unit 210 may further constrain (or permit the user to constrain) one or more dimensions of the box blank (e.g., a length of no greater than 72 inches). In response to the prompt, the user enters and control unit 210 receives the desired dimension(s) of the finished box via the touchscreen and/or user input device 114 (block 1006).

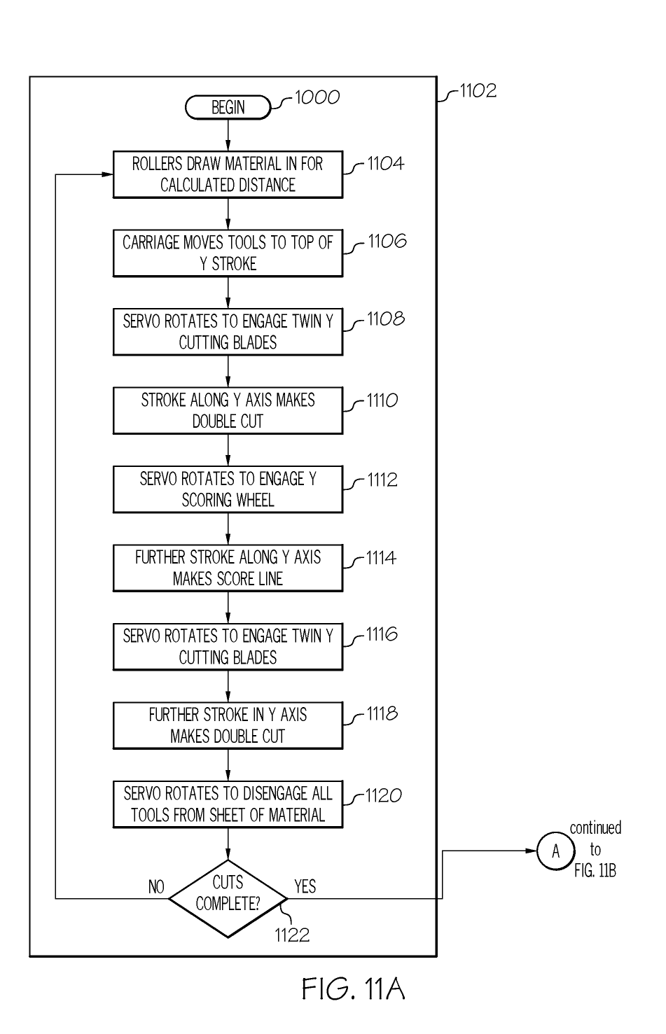

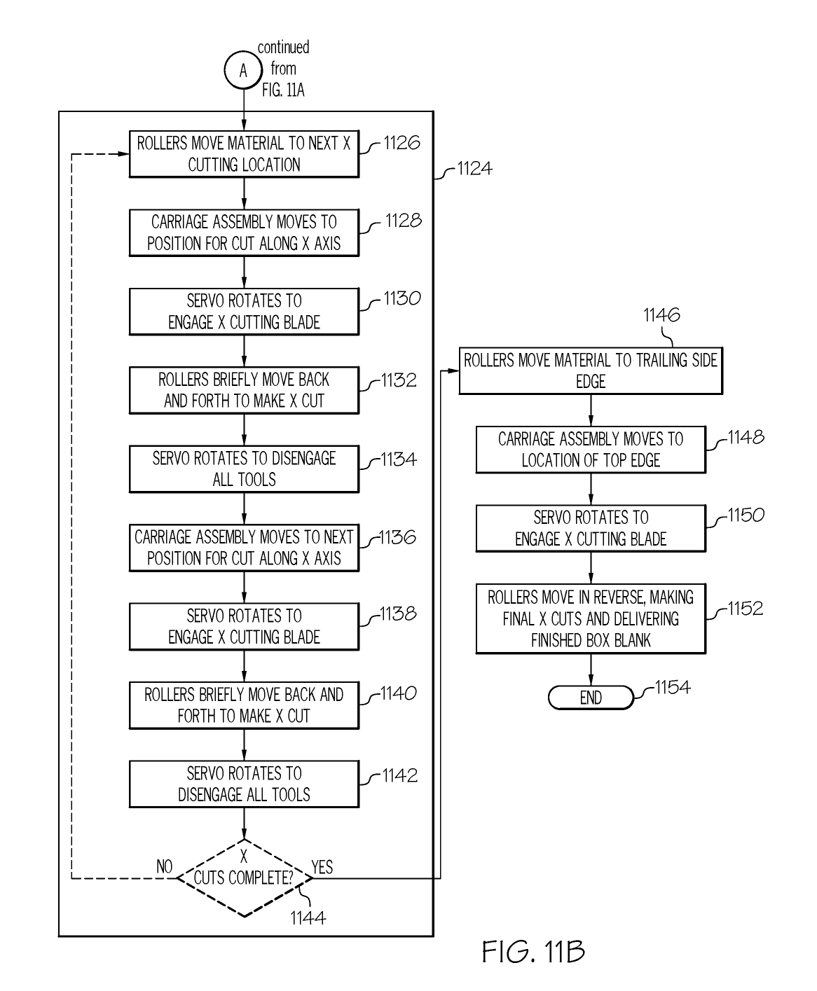

In response to entry of the desired dimension(s) of the finished box, control unit 210 controls axial gear motors 306, stepper motor 410, and servo motor 604 to cause sleeve engagement arm 804 to position sleeves 300 at appropriate locations along the Y axis to score a sheet of box-making material along the X axis (block 1007). In addition, control unit 210 prompts the user via display 212 and/or speaker 902 to insert a sheet of box-making material into slot 104 (block 1008). Block 1010 depicts the user inserting the sheet of box-making material into slot 104 so that the sheet of material engages rollers 230a, 230b. In response to detecting via slot entrance detector 904a that the user has inserted a sheet of box-making material into slot 104 that engages rollers 230a, 230b, control unit 210 directs machine 100 to process (e.g., cut, score and perforate) the sheet of material to form a box blank in a fully automated manner (block 1012), as described in detail below with reference to FIGS. 11A-11B. Once production of the box blank is complete, the user removes the box blank from machine 100 (block 1014). As indicated at block 1016, the user may then optionally fold the box blank along the scored and perforated lines in the box blank and secure the box in the folded configuration (e.g., by tape, glue, staples, etc.) to form a finished box. Alternatively, the user may instead retain the box blank in planar form for later use to form a box.

As represented by decision block 1018, in some embodiments, each box blank is individually created using individually customizable dimensions. In such embodiments, if the user desires to create another box of any desired permissible dimensions, the process of FIG. 10 is simply repeated from block 1004. In other embodiments, control unit 210 permits the user to further designate at block 1004 a number of boxes of a given set of dimensions to be created in a run. In this embodiment, the process of FIG. 10 can instead be repeated for all box blanks in the run beginning at block 1008, as indicated by optional decision block 1020 In response to a determination at block 1018 that no further box blanks are to be created at present, the process of FIG. 10 ends at block 1022.

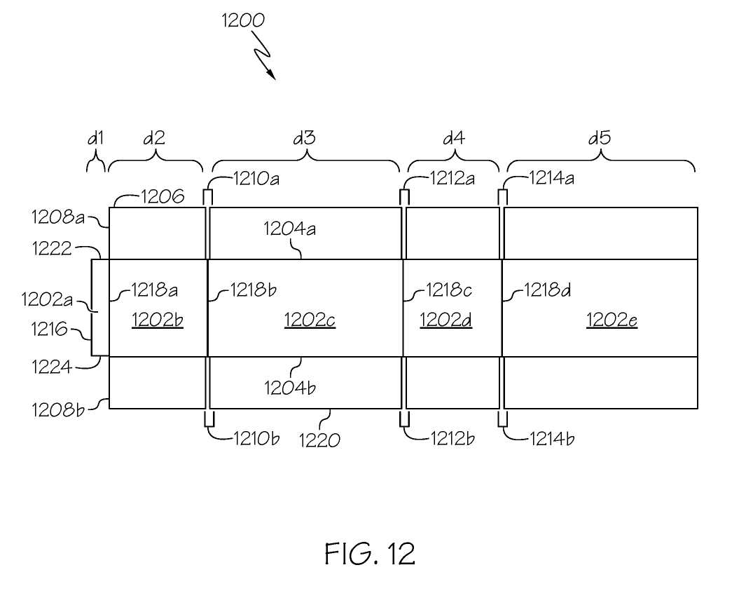

With reference now to FIGS. 11A-11B, there is illustrated a logical flowchart of the process by which a machine 100 processes a sheet of box-making material to form a box blank in accordance with one embodiment. The process of FIGS. 11A-11B can be performed, for example, at block 1012 of the process illustrated in FIG. 10. For ease of understanding, the process of FIGS. 11A-11B will be described with additional reference to FIG. 12, which provides a plan view of finished box blank 1200 produced by a machine 100 in accordance with one embodiment. It should be appreciated that in various embodiments at least some of the steps shown in FIGS. 11A-11B can be performed in a different order than illustrated and/or concurrently.

The process of FIGS. 11A-11B begins at block 1100 of FIG. 11A and then proceeds to a process loop 1102 including blocks 1104-1122 in which all cuts along the Y axis are made. Process loop 1102 begins at block 1104, which illustrates control unit 210 energizing relays 214 to cause rollers 230a, 230b to draw the sheet of box-making material into machine 100 via opposing slots 104 for a specified distance (FIG. 12: d1, d2, d3, d4 or d5) along the X axis. For example, in a first iteration of process loop 1102, the distance d5 corresponds to the length of panel 1202e; in the second iteration of the process loop 1102, the distance d4 corresponds to the length of panel 1202d; in the third iteration of the process loop 1102, the distance d3 corresponds to the length of panel 1202c; in the fourth iteration of the process loop 1102, the distance d2 corresponds to the length of panel1202b; and in the fifth iteration of the process loop 1102, the distance d1 corresponds to the length of tab 1202a. Distances d2 and d4 are preferably selected by control unit 210 to be equal to the desired width of the finished box, and distances d3 and d5 are preferably selected by control unit 210 to equal the desired length of the finished box. Distance d1, which determines the length of a tab 1202a, can be, but is not required to be, the same for all box sizes.

As will be appreciated, as rollers 230a, 230b draw the sheet of material into (and out of) the pair of opposing slots 104, raised ridges 304b and 304c grip and score the sheet of box-making material, forming in box blank 1200 the score lines 1204a and 1204b, respectively. It should be understood that score lines 1204a, 1204b are lines along which the sheet of box-making material is compressed along the Z axis to form natural fold (hinge) lines along which the box blank can readily be folded to form a finished box. Additional raised ridge 304a also grips and scores the sheet of box-making material near top edge 1206 as the sheet is drawn into and out of the pair of opposing slots 104, but the portion of the sheet scored by raised ridge 304a is cut from the sheet prior to completion of box blank 1200, as described further below with reference to block 1152 of FIG. 11B.

At block 1106, control unit 210 controls stepper motor 410 to move carriage 600 to a position along the Y axis corresponding to top edge 1206 of box blank 1200. Control unit 210 also controls servo motor 604 to rotate tool head 606 so that twin Y cutting blades 608 are in a cutting position (block 1108). With the Y cutting blades 608 in the cutting position, control unit 210 then controls stepper motor 410 to move carriage assembly 234 downward along the Y axis, thus making a double cut into the sheet of box-making material (block 1110). In the first iteration of process loop 1102, this cutting stroke defines slot 1214a of box blank 1200. In the second, third and fourth iterations of process loop 1102, this cutting stroke defines slot 1212a, slot 1210a and side edge 1208a respectively. In the fifth iteration of process loop 1102, the cutting stroke illustrated at block 1110 forms, if necessary, side edge 1216.

Following block 1110, control unit 210 controls servo motor 604 to rotate tool head 606 so that Y scoring wheel 610 is in scoring position (block 1112). With Y scoring wheel 610 in scoring position, control unit 210 then controls stepper motor 410 to move carriage assembly 234 downward along the Y axis, thus perforating the sheet of box-making material to form a score line (block 1114). This scoring stroke forms score lines 1218d, 1218c, 1218b and 1218a, respectively, in box blank 1200 in the first through fourth iterations of process loop 1102 and is preferably omitted in the fifth iteration of process loop 1102.

Control unit 210 then controls servo motor 604 to rotate tool head 606 so that twin Y cutting blades 608 are returned to the cutting position (block 1116). With the Y cutting blades 608 in the cutting position, control unit 210 then controls stepper motor 410 to move carriage assembly 234 downward along the Y axis, thus making a double cut into the sheet of box-making material (block 1118). In the first iteration of process loop 1102, this cutting stroke defines slot 1214b of box blank 1200. In the second, third and fourth iterations of process loop 1102, this cutting stroke defines slots 1212b, 1210b and trailing side edge 1208b, respectively. In the fifth iteration of process loop 1102, the cutting stroke illustrated at block 1118 is preferably omitted.

Following block 1118, control unit 210 controls servo motor 604 to rotate tool head 606 so that all tools are disengaged from the sheet of box-making material (block 1120). If all cuts along the Y axis have not been completed, control unit 210 continues process loop 1102, as represented by the process returning from block 1122 to block 1104. If, however, all cuts along the Y axis have been completed by process loop 1102, the process proceeds from block 1122 through page connector A to block 1126 of FIG. 11B. The processes performed in block 1126 through block 1142 illustrate machine 100 making the cuts along the X axis defining at least edges 1222 and 1224 of tab 1202a.

Block 1126 illustrates control unit 210 controlling rollers 230a, 230b to move the sheet of material along the X axis to a next cutting location, which in one embodiment is the location of tab 1202a. Control unit 210 additionally controls stepper motor 410 to position carriage assembly 234 to the appropriate location along the Y axis for making a cut along the X axis, for example, the lower edge 1224 of tab 1202a (block 1128). Control unit 210 also controls servo motor 604 to cause tool head 606 to move actuator arm 612 to rotate X cutting blade 620 into cutting position (block 1130). With X cutting blade 620 in cutting position, control unit 210 controls axial gear motors 306 to briefly rotate back and forth to make a cut along the X axis (block 1132). Following block 1132, control unit 210 controls servo motor 604 to rotate tool head 606 so that all tools are disengaged from the sheet of box-making material (block 1134).

Following block 1134, control unit 210 controls stepper motor 410 to position carriage assembly 234 at the appropriate location along the Y axis for making the next cut along the X axis, for example, the upper edge 1222 of tab 1202a (block 1136). Control unit 210 also controls servo motor 604 to cause tool head 606 to move actuator arm 612 to rotate X cutting blade 620 into cutting position (block 1138). With X cutting blade 620 in cutting position, control unit 210 controls axial gear motors 306 to briefly rotate back and forth to make a cut along the X axis (block 1140). Following block 1132, control unit 210 controls servo motor 604 to rotate tool head 606 so that all tools are disengaged from the sheet of box-making material (block 1142). In some embodiments in which no cuts are made along the bottoms of slots 1210a-1210b, 1212a-1212b, and 1214a-1214b, optional block 1144 is omitted, and the process passes directly from block 1142 to block 1146. In such embodiments, the waste material from slots 1210a-1210b, 1212a-1212b, and 1214a-1214b can simply be manually torn off by the operator. In other embodiments this waste material can be trimmed from the box blank by machine 100. Accordingly, in these alternative embodiments, at block 1144 control unit 210 causes a process loop 1124 including blocks 1126-1144 to be repeatedly performed to make the X axis cuts for slots 1210a-1210b, 1212a-1212b and 1214a-1214b.

Following an affirmative determination at block 1144, or if block 1144 is omitted following block 1142, the process proceeds to block 1146. Block 1146 depicts control unit 210 controlling axial gear motors 306 to cause rollers 230a-230b to rotate to move the sheet of material so that trailing side edge 1216 of box blank 1200 is aligned with carriage assembly 234. Control unit 210 additionally controls stepper motor 410 to position carriage assembly 234 at the appropriate location along the Y axis to cut top edge 1206 (block 1148). Control unit 210 also controls servo motor 604 to cause tool head 606 to move actuator arm 612 to rotate X cutting blade 620 into cutting position (block 1150). With X cutting blade 620 in cutting position, control unit 210 controls axial gear motors 306 to rotate in reverse to feed the sheet of box-making material back out of the entrance slot 104. In so doing, X cutting blade 620 cuts top edge 1206 into the sheet of box-making material, and X cutting blade 504 (if present) cuts bottom edge 1220 into the sheet of box-making material. With these cuts, production of box blank 1200 is completed. The process of FIGS. 11A-11B thereafter ends at block 1154.

As has been described, in at least one embodiment, a machine for making a box blank from a sheet of box-making material includes a frame, a plurality of rollers, coupled to the frame, for moving the sheet along a material handling path, and a rail coupled to the frame adjacent to the material handling path. The machine further includes a carriage assembly including a first motor and a blade selectively deployable by the first motor, a second motor that, via a linkage, moves the carriage assembly along the rail, and a control circuit that controls the first and second motors to selectively deploy the blade to cut the sheet to form a box blank.

While the present invention has been particularly shown as described with reference to one or more preferred embodiments, it will be understood by those skilled in the art that various changes in form and detail may be made therein without departing from the spirit and scope of the invention. For example, in the depicted embodiment, carriage assembly 234 to receive power and provide motor feedback via a moving portion of wiring harness 216. In other embodiments, power and feedback can alternatively be conducted via bare wires aligned with rail 240 and pick-ups that ride along the wires as carriage assembly 234 traverses rail 240. Further, although an embodiment has been described in which all X and Y cutting blades are passive, non-rotating blades, in other embodiments powered, rotating blades can alternatively be employed in place of one or more of the cutting blades. In addition, although the process of FIG. 11A-11B describes a process for making a box blank of a RSC, it should be appreciated that the process can be adapted (e.g., via configuration of control circuit 210) to produce box blanks for other types of boxes, such as telescoping boxes, overlapping flap boxes, or even partial box blanks that can be assembled to form a larger box.

The figures described above and the written description of specific structures and functions below are not presented to limit the scope of what Applicants have invented or the scope of the appended claims. Rather, the figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Consequently, reference to “an embodiment” or “one embodiment” may refer to multiple different embodiments. Lastly, the use of a singular term, such as, but not limited to, “a” is not intended as limiting of the number of items.

What is claimed is:

1. A machine for making a box blank from a sheet of box-making material, the machine comprising:
a frame;
a plurality of rollers, coupled to the frame, for moving the sheet along a material handling path;
a rail coupled to the frame and adjacent to the material handling path;
a carriage assembly including a first motor and a blade selectively deployable by the first motor;
a second motor that, via a linkage, moves the carriage assembly along the rail; and
a control circuit that controls the first and second motors to selectively deploy the blade to cut the sheet to form a box blank.

2. The machine of claim 1, wherein:
at least one of the plurality of rollers has a cavity formed therein; and
the machine further comprises a third motor disposed in the cavity that rotates the at least one roller under control of the control circuit.

3. The machine of claim 1, wherein:
at least one of the plurality of rollers has mounted thereon a plurality of sleeves for scoring the sheet to form fold lines of the box blank.

4. The machine of claim 1, wherein:
the plurality of sleeves are slidably mounted on the at least one roller; and
the carriage assembly further includes a selectively deployable sleeve positioning arm configured to reposition the plurality of sleeves along the at least one roller.

5. The machine of claim 1, and further comprising at least one position sensor, coupled to the control circuit, for sensing a position of the sheet along the material handling path.

6. The machine of claim 1, and further comprising a sensor, coupled to the control circuit, for sensing rotation of at least one of the plurality of rollers.

7. The machine of claim 1, and further comprising a user input device, coupled to the control circuit, through which at least one dimension of a finished box can be entered.

8. The machine of claim 1, wherein the machine weighs less than 100 pounds.

9. The machine of claim 1, wherein the blade is one of a pair of selectively deployable blades configured to make parallel cuts in the sheet along the rail.

10. The machine of claim 1, wherein:
the blade is first blade; and
the machine further comprises a second blade, mounted on the carriage assembly, that is selectively deployable to cut the sheet orthogonally to the rail.

11. The machine of claim 1, and further comprising a scoring wheel, mounted on the carriage assembly, to score the sheet along the rail.

12. The machine of claim 1, and further comprising a passive cutting blade configured to cut the sheet along the material handling path.

13. The machine of claim 1, wherein:
the second motor has a shaft; and
the linkage comprises a chain driven by a sprocket mounted on the shaft.

14. The machine of claim 1, wherein:
the carriage assembly includes a toolset including a plurality of tools including the blade; and
the carriage assembly further comprises an actuator arm selectively actuatable by the first motor to deploy one of the plurality of tools.

15. The machine of claim 1, wherein the box blank is a box blank for a regular slotted container.

16. The machine of claim 1, wherein:
the frame is configured to rest on a substrate; and
the material handling path is orthogonal to the substrate.

17. The machine of claim 1, wherein:
a first roller of the plurality of rollers has at least one cavity formed therein; and
a third motor disposed within the at least one cavity, wherein the third motor has a shaft fixed relative to the frame and a housing fixed relative to the roller.

18. A machine for making a box blank from a sheet of box-making material, the machine comprising:
a frame;
a plurality of rollers, coupled to the frame, for moving the sheet along a material handling path;
a plurality of sleeves mounted on at least one of the plurality of rollers for scoring the sheet to form fold lines of the box blank.
a rail coupled to the frame and adjacent to the material handling path;
a carriage assembly including a first motor and a blade selectively deployable by the first motor;
a second motor that, via a linkage, moves the carriage assembly along the rail; and
a control circuit that controls the first and second motors to selectively deploy the blade to cut the sheet to form a box blank.

19. The machine of claim 18, wherein:
the blade is a first blade that cuts the sheet along the rail;
the carriage assembly includes a toolset including a plurality of selectively deployable tools including at least the first blade and a second blade that cuts the sheet orthogonal to the rail.

20. The machine of claim 18, wherein:
a first roller of the plurality of rollers has at least one cavity formed therein; and
a third motor disposed within the at least one cavity, wherein the third motor has a shaft fixed relative to the frame and a housing fixed relative to the roller.

21. A roller assembly for a machine having a frame, the roller assembly comprising:
a roller having at least one cavity formed therein; and
an electric axial motor disposed within the at least one cavity, wherein the electric axial motor has a shaft fixed relative to the frame and a housing fixed relative to the roller.

22. The roller assembly of claim 21, wherein:
the electrical axial motor is a first electric axial motor;
the roller includes a second electric axial motor disposed within the at least one cavity and electrically connected in series with the first electric axial motor; and
the second electric axial motor has a shaft fixed relative to the frame and a housing fixed relative to the roller.

23. The roller assembly of claim 22, wherein the first and second electric axial motors are powered via the shafts of the first and second electric axial motors.

24. The roller assembly of claim 21, wherein the roller is insulated from the electric axial motor.
